(19) United States
(12) Patent Application Publication
(10) Pub. No.: US 2001/0030915 A1
(43) Pub. Date: Oct. 18, 2001

(54) Optical disc apparatus

(76) Inventor: Kenichi Suzuki, Chiba (JP)

Correspondence Address: FROMMER LAWRENCE & HAUG LLP, 745 FIFTH AVENUE, NEW YORK, NY, 10151, US

(21) Appl. No.: 09/757,547

(22) Filed: Jan. 10, 2001

(30) Foreign Application Priority Data
Jan. 12, 2000 (JP) 2000-006339
Jan. 19, 2000 (JP) 2000-014127

(51) Int. Cl. G11B 7/095

(52) U.S. Cl. 369/44.29

(57) ABSTRACT

Deterioration of an error rate due to disturbance of a reproduced signal is prevented by carrying out focus balance adjustment and tracking balance adjustment, with use of a focus control section for causing a focus servo to control the focus balance, based on a jitter value measured by a jitter measurement section, and a balance-adjusted FE signal generated by an error signal generating section, and a tracking control section for causing a tracking servo to control the tracking balance, based on an error center value measured by an error center measurement section and a balance-adjusted TE signal generated by an error signal generating section. Also, the focus servo carries out focus down-search thereby to switch on correctly the focus.

### BACKGROUND OF THE INVENTION

The present invention relates to an optical disc apparatus which balances the focus error signal and tracking error signal thereby to make defocus adjustment and detrack adjustment.

The present invention also relates to an optical disc apparatus which focuses an optical beam irradiated from an optical pickup, onto a signal recording surface of an optical disc or the like, with use of a return signal from the optical disc or the like.

Recently, an objective lens (herein after called a two-focus lens) having focuses at two positions in the optical axis direction is used to reproduce a CD (Compact Disc), a DVD (Digital Versatile Disc) by one optical disc reproduction apparatus.

Conventionally, in an optical disc reproduction apparatus, defocus and detrack adjustments are automatically made at starting of the apparatus. The defocus adjustment is performed such that an optical beam from an optical pickup is focused on a signal recording surface of an optical disc at a best jittering point. The detrack adjustment is performed such that the optical beam precisely traces a track on the signal recording surface of the optical disc. Conventionally, these defocus and detrack adjustments are achieved by applying a bias voltage (offset voltage).

Further, in the optical disc reproducing apparatus comprising the two-focus lens capable of reproducing the CD and DVD, the defocus for a CD and that for a DVD differ from each other so that the bias voltage value at which defocus adjustment is performed is set to a large value.

Further, in conventional cases of reproducing an optical disc, the objective lens of an optical pickup is focused on the optical disc in a direction in which the objective lens gets closer to the optical disc.

Meanwhile, when a damaged optical disc is reproduced with use of an optical disc apparatus whose bias voltage value is set as described above, both of focusing and tracking cause problems described below.

A first problem occurs while reproducing a damaged optical disc. That is, as shown in FIG. 1, the drive voltage is held for a damaged portion. The error signal is not detected and therefore comes closer to zero. Before and after the damaged portion, there occurs an offset equivalent to a bias voltage which has been applied to the error signal to make adjustment thereon. Further, after passing the damaged portion, an offset voltage is applied again to the error signal and the servo system therefore follows the error, so that the drive voltage is disturbed. Due to the disturbance of the drive voltage, the signal reproduced from the optical disc is influenced and its waveform is disturbed so that the error rate may be deteriorated.

A second problem occurs in case where there is a difference between the level of damage at the position of the optical disc when defocus adjustment and detrack adjustment are carried out automatically and the level of damage at the position of the optical disc when it is reproduced. That is, the amount of returning light from the optical disc is remarkably lowered at damaged portions, so that a fixed offset voltage value subjected to automatic adjustment shifts greatly from an optimum value depending on the position of the optical disc.

Further, if a CD is reproduced with use of an optical disc reproducing apparatus comprising a two-focus as lens described above, a signal called an S-shaped fake is generated before a true S-shaped signal for detecting switching-on of the focus servo because of existence of two focuses, during so-called up-search in which the two-focus lens is moved in the direction in which the lens comes closer to the optical disc from a distant position, thereby to achieve focusing.

The signal called an S-shaped fake and the true S-shaped signal have large variants, so that fixed level detection is difficult to carry out. In addition, the switching-on of the focus fails if the optical disc reproducing apparatus turns on the focus servo, mistaking a signal called an S-shaped fake as a true S-shaped signal. In order to avoid the failure, it may be possible to carry out so-called down-search in which the objective lens is focused on the optical disc in a direction in which the lens moves apart from a position closer to the optical disc than the focus position.

In the down-search, however, the objective lens comes closer to the optical disc, passing by the focus position, and the objective lens collides into the optical disc if the lens is kept moved up as it is. The optical disc may then be damaged. In addition, since focus distances of the two-focus lens are short because of the characteristics of the lens, it is difficult to provide a mechanical stopper for stopping collision between the optical disc and the objective lens in design, in consideration of the surface blurring during rotation of the optical disc.

### BRIEF SUMMARY OF THE INVENTION

The present invention hence has been made in view of the situation as described above and has a first object of providing an optical disc apparatus which prevents deterioration of an error rate due to disturbance of a reproduced signal.

The present invention also has a second object of providing an optical disc apparatus in which the focus is correctly switched on by performing focus down-search with use of a focus zero-cross detection signal and/or an FOK signal.

To achieve the first object, an optical disc apparatus according to the present invention comprises: an optical pickup for irradiating a light beam through a two-focus lens onto a signal recording surface of an optical disc including the signal recording surface where digital data is recorded to be optically readable, and for detecting reflection light thereof; drive control means for driving and controlling the two-focus lens in an optical axis direction of the light beam; focus error center value measurement means for measuring a focus error center value detected by the optical pickup; focus error signal generation means for generating a focus error signal subjected to balance-adjustment based on the reflection light and a variable coefficient Kf; and focus balance control means for causing the drive control means to control a focus balance, based on the focus error center value measured by the focus error center value measurement means, and the focus error signal generated by the focus error signal generation means and subjected to the balance adjustment.

In this optical disc apparatus, the focus balance control means causes the drive control means to control the focus balance, based on the focus error center value and the balance-adjusted focus error signal.

Another optical disc apparatus according to the present invention comprises: an optical pickup for irradiating a light beam through a two-focus lens onto a signal recording surface of an optical disc including the signal recording surface where digital data is recorded to be optically readable, and for detecting reflection light thereof; drive control means for driving and controlling the two-focus lens in a radial direction of the optical disc; tracking error center value measurement means for measuring a tracking error center value detected by the optical pickup; tracking error signal generation means for generating a tracking error signal subjected to balance-adjustment based on the reflection light and a variable coefficient Kt; and tracking balance control means for causing the drive control means to control a tracking balance, based on the tracking error center value measured by the tracking error center value measurement means, and the tracking error signal generated by the tracking error signal generation means and subjected to the balance adjustment.

In this optical disc apparatus, the tracking balance control means causes the drive control means to control the tracking balance, based on the tracking center value and the balance-adjusted tracking error signal.

Further, to achieve the second object, an optical disc apparatus according to the present invention comprises: an optical pickup for irradiating a light beam through an objective lens onto a signal recording surface of an optical disc including the signal recording surface where digital data is recorded to be optically readable, and for detecting reflection light thereof; focus error signal detection means for detecting a focus error signal, based on the reflection light detected by the optical pickup; focus zero-cross detection signal detection means for detecting a focus zero-cross detection signal, based on the focus error signal detected by the focus error signal detection means; and drive control means for driving and controlling the objective lens in an optical axis direction of the light beam, wherein, if the objective lens is being driven at a predetermined speed in a direction in which a distance from the optical disc is shortened, the drive control means stops the objective lens moving closer to the optical disc upon elapse of a predetermined time period from when the focus zero-cross detection signal which has been by the focus zero-cross detection signal detection means is not detected any more, and if the objective lens is being driven after the stopping of the objective lens, in a direction in which the distance from the optical disc is increased, the drive control means controls a focus position of the light beam irradiated from the optical pickup to be focused on the signal recording surface of the optical disc, based on the focus zero-cross detection signal.

Another optical disc apparatus according to the present invention comprises: an optical pickup for irradiating a light beam through an objective lens onto a signal recording surface of an optical disc including the signal recording surface where digital data is recorded to be optically readable, and for detecting reflection light thereof; pull-in signal detection means for detecting a pull-in signal, based on a total light amount of the reflection light detected by the optical pickup; FOK signal detection means for detecting an FOK signal, based on the pull-in signal detected by the pull-in signal detection means; and drive control means for driving and controlling the objective lens in an optical axis direction of the light beam, wherein, if the objective lens is being driven at a predetermined speed in a direction in which a distance from the optical disc is shortened, the drive control means stops the objective lens moving closer to the optical disc upon elapse of a predetermined time period from when the FOK signal which has been by the FOK signal detection means is not detected any more, and if the objective lens is being driven after the stopping of the objective lens, in a direction in which the distance from the optical disc is increased, the drive control means controls a focus position of the light beam irradiated from the optical pickup to be focused on the signal recording surface of the optical disc, based on the FOK signal.

Further, another optical disc apparatus according to the present invention comprises: an optical pickup for irradiating a light beam through an objective lens onto a signal recording surface of an optical disc including the signal recording surface where digital data is recorded to be optically readable, and for detecting reflection light thereof; focus error signal detection means for detecting a focus error signal, based on the reflection light detected by the optical pickup; focus zero-cross detection signal detection means for detecting a focus zero-cross detection signal, based on the focus error signal detected by the focus error signal detection means; pull-in signal detection means for detecting a pull-in signal, based on a total light amount of the reflection light detected by the optical pickup; FOK signal detection means for detecting an FOK signal, based on the pull-in signal detected by the pull-in signal detection means; and drive control means for driving and controlling the objective lens in an optical axis direction of the light beam, wherein, if the objective lens is being driven at a predetermined speed in a direction in which a distance from the optical disc is shortened, the drive control means stops the objective lens moving closer to the optical disc upon elapse of a predetermined time period from when the focus zero-cross detection signal which has been by the focus zero-cross detection signal detection means or the FOK signal which has been detected by the FOK signal detection means is not detected any more, and if the objective lens is being driven after the stopping of the objective lens, in a direction in which the distance from the optical disc is increased, the drive control means controls a focus position of the light beam irradiated from the optical pickup to be focused on the signal recording surface of the optical disc, based on the focus zero-cross detection signal and the FOK signal. As has been described above, according to the present invention, the focus balance and the tracking balance are controlled so that no offset voltage is applied. Therefore, there is no disturbance of the drive voltage caused as the drive voltage for the focusing and tracking follows the offset voltage after a light beam from the optical pickup passes by a damaged portion. Also, according to the optical disc apparatus of the present invention, bias adjustment does not depend on a fixed offset voltage value even if the level of damage differs between the position of the optical disc when defocusing and detracking are automatically adjusted and the position thereof when it is reproduced. Therefore, the bias value does not come out of an optimal bias value.

Also, according to the optical disc apparatus of the present invention, it is possible to avoid a signal called an S-shaped fake from occurring immediately before a true S-shaped signal due to use of a two-focus lens when focusing the objective lens in the direction in which the lens is moved closer to the optical disc. It is therefore possible to prevent erroneous switching-on of the focus caused by mistaking the signal called an S-shaped fake as a focus error signal.

Further, according to the optical disc apparatus of the present invention, the motion of moving the objective lens closer to the optical disc is controlled by a return signal from the optical disc. Therefore, it is unnecessary to carry out processing for preventing the objective lens and the optical disc from contacting each other.

### BRIEF DESCRIPTION OF THE SEVERAL VIEWS OF THE DRAWINGS

FIG. 1 is an explanatory view of a problem in focus bias adjustment;

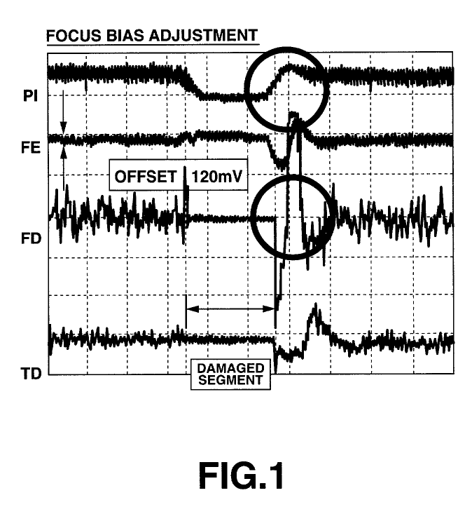

FIG. 2 is a block diagram of the structure of an optical disc apparatus showing an embodiment to which the present invention is applied;

FIG. 3 is a view showing the layout structure of photodiodes of an optical pickup in an embodiment to which the present invention is applied;

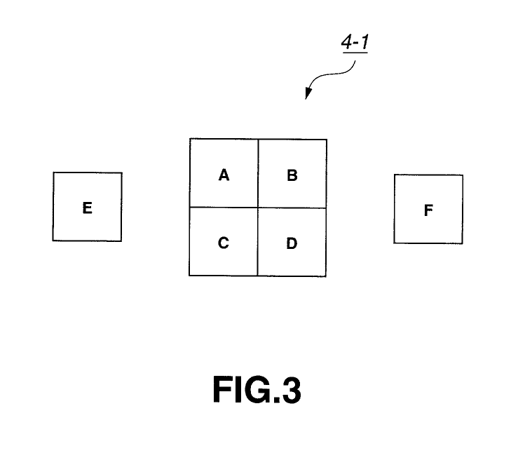

FIG. 4 is an explanatory view of focus bias adjustment and focus balance adjustment;

FIG. 5 is a flowchart which explains the flow of processing when defocusing is automatically adjusted;

FIG. 6 is a flowchart which explains the flow of processing when detracking is automatically adjusted;

FIG. 7 is a block diagram showing the structure of an optical disc apparatus showing an embodiment to which the present invention is applied; and

FIG. 8 is an explanatory view of processing of switching to down-search after up-search thereby to focus on the optical disc 102.

### DETAILED DESCRIPTION OF THE INVENTION

Embodiments to which the present invention is applied will be explained with reference to the drawings.

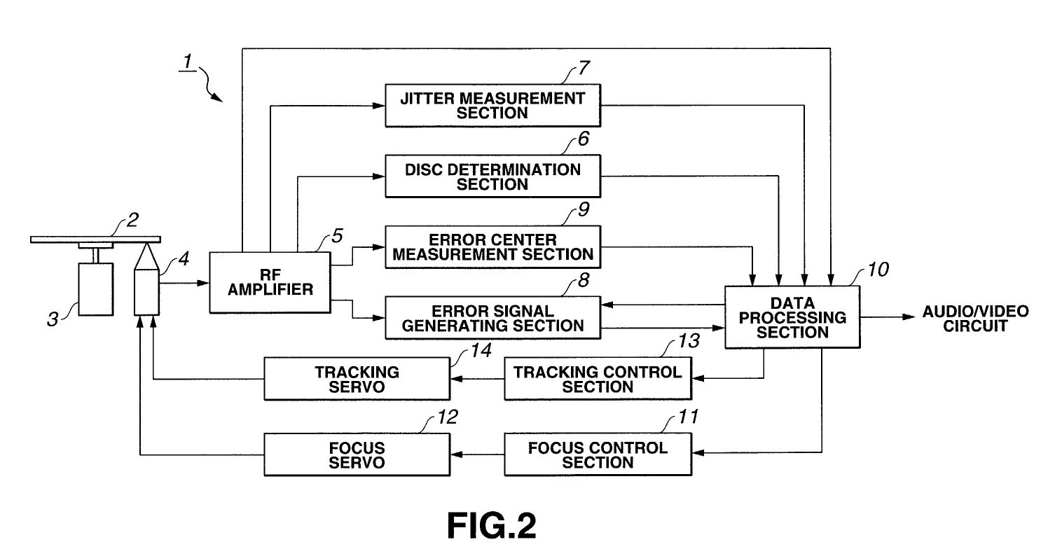

An optical disc apparatus as a first embodiment to which the present invention is applied comprises an objective lens (hereinafter called a two-focus lens) which has focuses at two positions in the optical axis direction. FIG. 2 shows an optical disc apparatus according to the embodiment to which the present invention is applied.

The optical disc apparatus 1 comprises an optical disc 2, a spindle motor 3, an light pickup 4, a RF amplifier 5, a disc determination section 6, a jitter measurement section 7, an error signal generating section 8, an error center measurement section 9 and data processing section 10, a focus control section 11, a focus servo 12, a tacking control section 13, and a tracking servo 14.

The optical disc 2 may be any of optical discs having different disc formats, such as a CD (Compact Disc), a DVD (Digital Versatile Disc), and the like and is driven and rotated by the spindle motor 3.

The optical pickup 4 uses a two-focus lens not shown, as an objective lens, and further has a two-axis actuator, a semiconductor laser device, and a light detecting section. The light detecting section 4-1 of the optical pickup 4 is constructed by tetramerous photodiodes A, B, C, and D and photodiodes E and F arranged before and after the tetramerous photodiodes. The light detecting section 4-1 of the optical pickup 4 supplies the RF amplifier 5 with detection signals A, B, C, and D detected by the photodiodes A, B, C, and D and also with detection signals E and F detected by the photodiodes E and F.

Note that the optical pickup 4 is controlled to move 1n the radial direction of the disc by a feed motor not shown.

The RF amplifier 5 calculates (A+B+C+D) with use of the detection signals A, B, C, and D supplied from the optical pickup 4. A RF signal as a result of this calculation is wave-shaped by a waveform shaping circuit not shown, thereby to convert into a binary RF signal. Further, the RF amplifier 105 supplies the data processing section 10 with the converted binary RF signal.

Based on the detection signals A, B, C, and D supplied from the optical pickup 4, the RF amplifier 5 generates a pull-in signal (hereinafter called PI signal) as a signal which relates to the whole amount of light received by the light detecting section of the optical pickup 4, and supplies the PI signal to the disc determination section 6.

Further, based on the detection signals A, B, C and D, the RF amplifier 5 measures an amplitude value of the whole amount of light received by the light detecting section of the optical pickup 4 and supplies an error center measurement section 9 with an amplitude value of the measured total amount of light.

Furthermore, the RF amplifier 5 supplies an error signal generating section 8 with the detection signals A, B, C, and D and the detection signals E and F which are supplied from the optical pickup 4.

From the RF signal supplied from the RF amplifier 5, the disc determination section 6 generates a mirror signal (hereinafter called a surface reflection disc detection signal) based on surface reflection of the optical disc 2 and a mirror signal (hereinafter called a signal surface reflection disc detection signal) based on signal surface reflection of the optical disc 2. The disc determination section 6 determines the type of the optical disc 2, based on the generated surface reflection disc detection signal and signal reflection disc detection signal.

Specifically, the disc determination section 6 measures a period for which the surface reflection disc detection signal and the signal surface reflection disc detection signal are detected. If this period is a period T1, for example, the optical disc 2 is determined to be a CD. Alternatively, if it is a period T2 longer than the period T1, the disc is determined to be a DVD. This determination utilizes a difference in thickness between the discs, i.e., the thickness of the CD is 1.2 mm and the thickness of the DVD is 0.6 mm.

Two focus positions are set for the two-focus lens of the optical pickup 4, so as to correspond to the two types of discs described above.

Also, if the optical disc 2 is determined to be a DVD based on the PI signal supplied from the RF amplifier 5, the disc determination section 6 determines whether one side of the optical disc 2 has one layer or two layers. Specifically, the disc determination section 6 determines that one side has one layer, if the light reflection rate of the optical disc 2 is 45 to 85% on the basis of the PI signal, or the section 6 determines that one side has two layers if the light reflection rate of the optical disc 2 is 18 to 30%. Note that the PI signal herein used is also a low frequency component.

The disc determination section 6 supplies the data processing section 10 with, a result of thus determining the type of the optical disc 2 (hereinafter called disc determination result information).

The jitter measurement section 7 measures a jitter level with respect to the RF signal supplied from the RF amplifier 5 and supplies the data processing section 10 with a measured value.

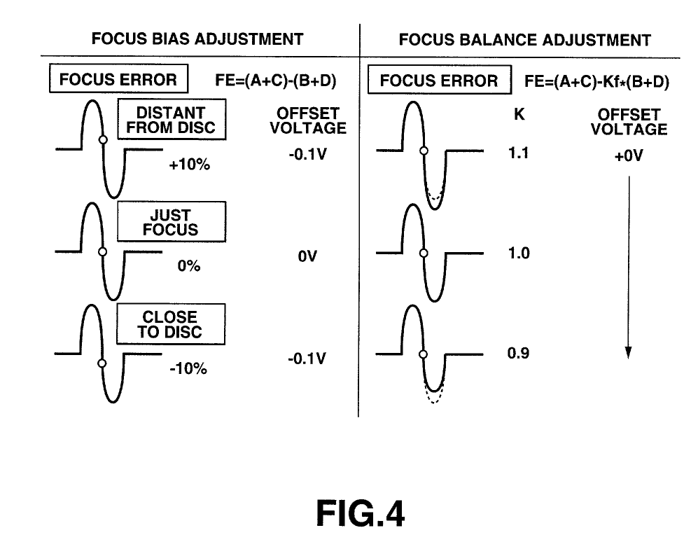

The error signal generating section 8 calculates (A+C)-K(B+D), as shown in FIG. 4, using the detection signals A, B, C, and D and a coefficient Kf set by the data processing section 10. The section 8 supplies the data processing section 10 with the calculated result as a balance-adjusted focus error signal (hereinafter called a balance-adjusted FE signal).

The coefficient Kf is a coefficient programmed in advance in the data processing section 10 and takes a value of Kf=1.07, 1.14, 1.20, 1.26, 1.33, . . . or Kf=0.95, 0.88, 0.82, 0.76, . . . from an initial value of Kf0=1.0.

Also, the error signal generating section 8 calculates E-Kt*F, using the detection signals E and F supplied from the RF amplifier 5 and the coefficient Kt set by the data processing section 10, and outputs the calculated result as a balance-adjusted tracking error signal (hereinafter called a balance-adjusted TE signal) to the data processing section 10.

The coefficient Kt herein used is a coefficient programmed in advance and takes Kt=1.10, 1.21, 1.33, 1.46, 1.61, . . . or Kt=0.91, 0.83, 0.75, 0.68, . . . from an initial value of Kt0=1.0.

The error center measurement section 9 supplies the data processing section 10 with an error center measurement value.

The data processing section 10 performs demodulation processing on the binary RF signal supplied from the RF amplifier, generates an information signal such as audio/video data or the like, and supplies an audio/video circuit not shown with the audio/video data.

The data processing section 10 recognizes, for example, whether the optical disc 2 is a CD or DVD, based on the disc determination result information supplied from the disc determination section 6. The data processing section 10 also recognizes whether or not one side has one layer or two layers if the optical disc 2 is a DVD.

Further, the data processing section 10 controls the focus balance, based on an error center value and a balance-adjusted FE signal supplied from the error signal generating section 8. Specifically, the data processing section 10 changes the value of the coefficient Kf, based on the error center value and the balance-adjusted FE signal, until a minimum difference is obtained between the FE signal and the error center value. The error signal generating section 8 is caused to generate a balance-adjusted FE signal. The data processing section 10 supplies the focus control section 11 with the balance-adjusted FE signal thus generated, thereby to cause the focus control section 11 to control of focus balance.

Further, if just-focus is not achieved even after controlling the focus balance, the data processing section 10 supplies a bias control signal to the focus bias voltage adjustment section not shown but comprised in the focus control section 11, thereby to cause the focus bias voltage adjustment section to supply a focus bias voltage to a focus servo 12. The focus servo 12 thus supplied with a focus bias voltage from the focus bias voltage adjustment section drives thereby the two-axis actuator of the optical pickup 4 so as to make fine adjustment for just focus.

Further, the data processing section 10 also controls tracking balance, based on the error center measurement value supplied from the error center measurement section 9 and the balance-adjusted TE signal supplied from the error signal generating section 8. Specifically, based on the error center measurement value and the balance-adjusted TE signal, the data processing section 10 changes the value of the coefficient Kt such that the main beam spot comes just above the recording track. The error signal generating section 8 is thereby caused to generate a balance-adjusted TE signal. The data processing section supplies the tracking control section 13 with the balance-adjusted TE signal thus generated, thereby to let the tracking control section 13 control the tracking balance.

Further, the data processing section 10 supplies a bias control signal to a tracking bias voltage adjustment section not shown but comprised in the tracking control section 13 if just-track is not achieved even after controlling the tracking balance. In this manner, the tracking bias voltage adjustment section is caused to supply a tracking bias voltage to the tracking servo 14. The tracking servo 14 is supplied with the tracking bias voltage from the tracking bias voltage adjustment section, thereby driving a two-axis actuator of the optical pickup so that fine adjustment for just tracking is carried out.

In the optical disc apparatus 1 thus constructed, the focus servo 12 performs focus balance, based on a control signal from the focus control section 11. The tracking servo 14 performs tacking balance, based on a control signal from the tracking control section 13.

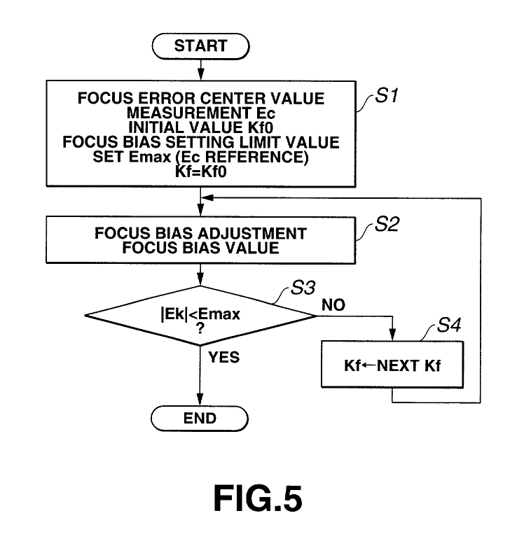

Next, the flow of processing when automatic adjustment of defocusing is carried out will be explained with reference to the flowchart shown in FIG. 5.

At first, in the step S1 shown in FIG. 5, the semiconductor laser device of the optical pickup 4 is turned on so as to measure the error center value. With the objective lens kept sufficiently distant from a just-focus point, the error center value is measured, and the measured error center value is taken as Ec. In this manner, it is possible to measure an error center value from which optical and electric offsets are removed.

Subsequently, a focus bias setting limit value Emax is set. Further, in the data processing section 10, the coefficient K used for generating a balance-adjusted FE signal is set to Kf0=1.0 as an initial value. With use of the value of Kf0=1.0, the error signal generating section 8 is caused to generate the balance-adjusted FE signal.

Subsequently, in the step S2, focus-bias adjustment is performed, and a focus bias value Ek which gives the center value between defocus values at two points where jittering has a minimum value or is sharply deteriorated is stored into the memory.

In the subsequent step S3, the data processing section 10 determines whether or not the absolute value of the focus bias value Ek is greater than the focus bias setting limit value Emax. If the absolute value of the present focus bias setting limit value Ek is determined to be greater than the focus bias setting limit value Emax, the processing is ended. In this manner, coarse adjustment can be made with use of the value of Kf while fine adjustment can be achieved by focus bias adjustment.

On the other hand, if the data processing section 10 determines the absolute value of the present bias value Ek to be greater than the focus bias setting limit value Emax, the processing goes to the step S4.

Subsequently, in the step S4, the data processing section 10 substitutes Kf with next Kf, and the processing returns to the step S2.

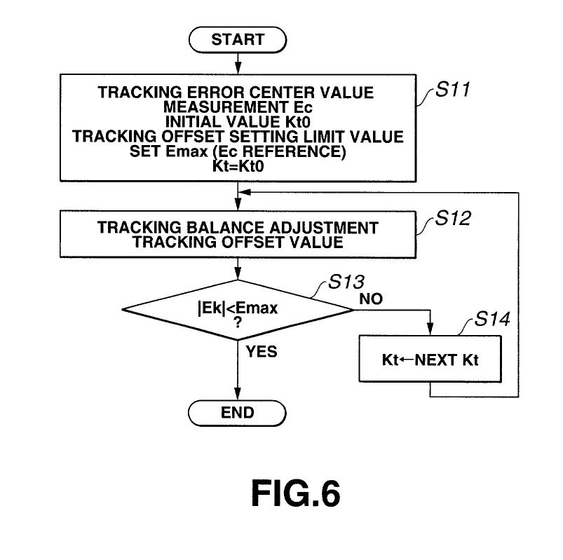

Next, the flow of processing when automatic adjustment of detracking is carried out will be explained with reference to the flowchart shown in FIG. 6.

At first, in the step S11 shown in FIG. 6, the laser device is normally turned on so as to measure the error center value, and the error center value is measured with the objective lens kept sufficiently distant from a just focus point. This measured error center value is taken as Ec. In this manner, it is possible to measure an error center value from which optical and electric offsets are removed.

Subsequently, a tracking bias limit value Emax is set. This value is set with reference to the error center value Ec described above. Further, the data processing section 10 sets the value of the coefficient K used to generate a balance-adjusted TE signal, to Kt0=1.0. With use of this Kt0=1.0, the error signal generating section 8 is caused to generate a balance-adjusted TE signal.

Subsequently, in the step S12, tracking offset adjustment is carried out. The data processing section 10 measures the amplitude of tracking error, calculates a center point thereof, and stores an offset value Ek which minimizes the offset, into a memory.

In the subsequent step S13, the data processing section 10 determines whether the absolute value of the tracking offset value Ek is greater than the tracking bias setting limit value Emax. Further, if the data processing section 10 determines that the absolute value of the present tracking offset value Ek is not greater than the tracking bias setting limit value Emax, the processing is ended. In this manner, coarse adjustment can be made with use of the value of Kt, which fine adjustment can be made by means of the tracking offset adjustment.

On the other hand, if the data processing section 10 determines that the absolute value of the present tracking offset value Ek is greater than the tracking bias setting limit value Emax, the processing goes to the step S14.

Subsequently, in the step S 14, the data processing section 10 substitutes Kt with next Kt, and the processing then returns to the step S12.

As described above, in the optical disc apparatus 1 as an embodiment to which the present invention has been applied, the focus servo 12 makes control of the focus balance, based on a control signal from the focus control section 11, so that no offset voltage is applied. Therefore, there is no disturbance of the driving voltage which occurs because the driving voltage for focusing and tracking follow the offset voltage after a light beam from the optical pickup 4 passes a damaged portion. It is thus possible to prevent deterioration of an error rate which may be caused by such a disturbance. Also, in the optical disc apparatus 1 as an embodiment to which the present invention is applied, bias adjustment is not carried out with a fixed offset voltage value, and therefore, the bias value does not go out of an optimum bias value, even if the position of the optical disc differs between when defocusing adjustment and detracking adjustment are automatically carried out and when it is reproduced.

In the optical disc apparatus 1 described above, a CD or DVD is used as the optical disc 2. However, the present invention is applicable to a different kind of disc other than a CD and a DVD as long as the optical disc apparatus is compatible with a disc having a different recording density.

Next, a second embodiment to which the present invention is applied will be explained with reference to the drawings.

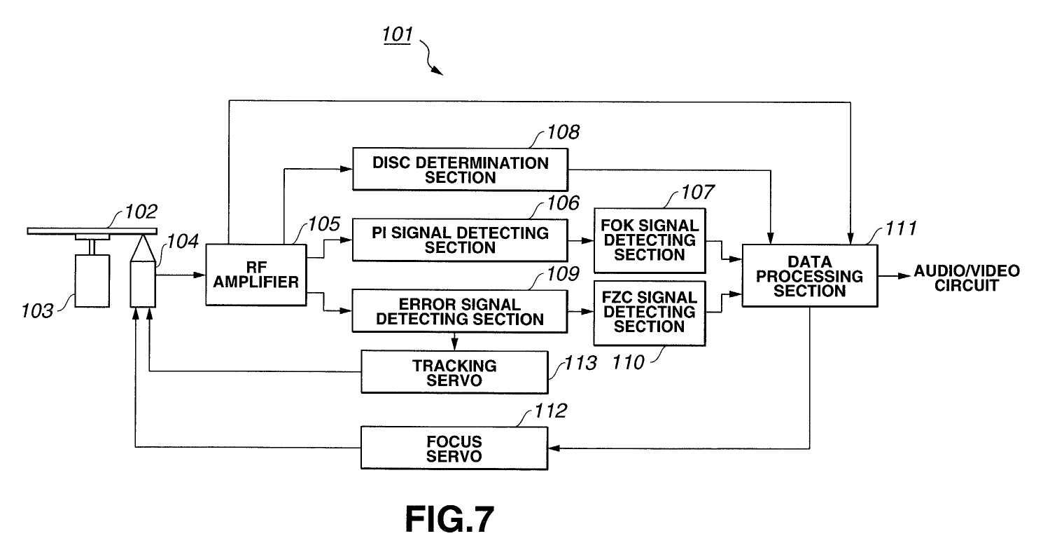

An optical disc apparatus as the second embodiment to which the present invention is applied is an apparatus in which an objective lens (hereinafter called a two-focus lens) having focuses at two positions in the optical axis direction are focused on an optical disc in the direction in which the lens comes apart from the disc, i.e., so-called down-search is performed. FIG. 7 shows the optical disc apparatus as an embodiment to which the present invention is applied.

In the optical disc apparatus as an embodiment to which the present invention is applied, at first, the two-focus lens is moved at a constant speed closer in the direction toward the optical direction. After a predetermined time period from when a focus position is passed over, up-search is stopped. Thereafter, the two-focus lens is focused on the optical disc in the direction in which the two-focus lens comes apart from the optical disc.

As shown in FIG. 7, the optical disc apparatus 101 comprises an optical disc 102, a spindle motor 103, an light pickup 104, a RF amplifier 105, a PI signal (pull-in signal) detecting section 106, a FOK signal detecting section 107, a disc determination section 108, an error signal detecting section 109, a FZC signal (focus zero-cross detection signal) detecting section 110, a data processing section 111, a focus servo 112, and a tracking servo 113.

The optical disc 102 is, for example, a CD (Compact Disc), a DVD (Digital Versatile Disc), or the like and is driven to rotate by the spindle 103.

The optical pickup 104 uses a two-focus lens not shown, as an objective lens, and further includes a two-axis actuator which drives the two-axis lens in the focusing direction and the tracking direction, a semiconductor laser and a light detecting section. As shown in FIG. 2 like the first embodiment described above, a light detecting section of the optical pickup 104 is constructed by four-divided photodiodes A, B, C, and D, and photodiodes E and F arranged longitudinally or laterally, and receives reflection light obtained by irradiating a laser beam on the signal surface of the optical disc 102. A light detecting section 104-1 of the optical pickup 104 supplies the RF amplifier 105 with detection signals A, B, C, and D detected by the photodiodes A, B, C, and D and detection signals E and F detected by the photodiodes E and F.

Note that the optical pickup 104 is controlled to move in the radial direction by a feed motor not shown.

The RF amplifier 105 calculates (A+B+C+D) with use of the detection signals A, B, C, and D supplied from the optical pickup 104. A RF signal as a result of this calculation is wave-shaped by a waveform shaping circuit not shown, thereby to convert into a binary RF signal. Further, the RF amplifier 105 supplies the data processing section 111 with the converted binary RF signal.

Also, the RF amplifier 105 calculates (A+C)−(B+D) with use of detection signals A, B, C, and D supplied from the optical pickup 104, and supplies a result of this calculation (hereinafter called a FE signal) as a focus error signal to the error signal detecting section 109.

Further, the RF amplifier 105 calculates (E−F) with use of the detection signals E and F supplied from the optical pickup 104, and supplies a result of this calculation as a tracking error signal (hereinafter called a TE signal) to the error signal detecting section 109.

Furthermore, based on the detection signals A, B, C, and D, the RF amplifier 105 generates a pull-in signal (hereinafter called a PI signal) as a signal which relates to the whole amount of light received by the optical pickup 104. The RF amplifier further supplies a PI signal detecting section 106 with the PI signal.

The PI signal detecting section 106 detects the PI signal supplied from the RF amplifier 105, and generates FOK as a signal obtained by comparing the amount of whole light received by the light detecting section of the optical pickup 104, with a predetermined threshold value. Further, the PI signal detecting section 106 supplies the FOK signal detecting section 107 with the generated FOK signal.

This FOK signal is also a signal expressing a range where the focus can be led in.

Upon detection of a FOK signal supplied from the PI signal detecting section 106, the FOK signal detecting section 107 generates a signal (hereinafter called a FOK detection signal) for recognizing detection of a FOK signal and supplies the data processing section 111 with the FOK detection signal.

The disc determination section 108 generates a mirror signal (hereinafter called a surface reflection disc detection signal) based on surface reflection of the optical disc 102 and a mirror signal (hereinafter called a signal surface reflection disc detection signal) based on signal surface reflection of the optical disc 102, from the RF signal supplied from the RF amplifier 105. Based on the surface reflection disc detection signal and the signal surface reflection disc detection signal, the section 108 determines the type of the optical disc 102.

Specifically, the disc determination section 108 measures a period for which the surface reflection disc detection signal and the signal surface reflection disc detection signal are detected. If this period is, for example, a period T1, the optical disc 102 is determined to be a CD. Alternately, if the period is a period T2 longer than the period T1, the optical disc 102 is determined to be a DVD. This determination utilizes a difference in thickness between disc substrates, i.e., a CD has a disc substrate whose thickness is 1.2 mm and a DVD has a disc substrate whose thickness is 0.6 mm. Two focus points are set in the two-focus lens of the optical pickup 104 so as to correspond to the two types of discs described above.

Also, if the optical disc 102 is determined to be a DVD on the basis of the PI signal supplied from the PI signal detecting section, the disc determination section 108 determines whether or not one side of the optical disc 102 includes one layer or two layers. For example, if the reflection rate of the optical disc 102 is 45 to 85%, the disc determination section 108 determines that one layer is on one side. If the reflection rate of light is 18 to 30%, two layers are determined to be included on one side. Note that the PI signal used herein is also a low-frequency component of the RF signal.

The disc determination section 108 supplies the data processing section 111 with a result (hereinafter called disc determination result information) of determining the type of the optical disc 102.

The error signal detecting section 109 detects a FE signal supplied from the RF amplifier 105, and generates a focus zero-cross detection signal (hereinafter called a FZC signal) as a signal obtained by comparing a S-shaped wave component with a predetermined threshold value, based on the FE signal detected as a S-shaped wave component. Further, the error signal detection signal 109 supplies the FZC signal detecting section.110 with the generated FZC signal.

Also, the error signal detecting section 109 detects a TE signal supplied from the RF amplifier 105, and generates a control signal for controlling the tracking, based on the detected TE signal. Further, the error signal generating section 109 supplies the tracking servo 113 with the generated control signal.

Upon detection of a FZC signal supplied from the error signal detecting section 109, the FZC signal detecting section 110 generates a signal (hereinafter called a FZC detection signal) for recognizing the detection of a FZC signal, and supplies the data processing section 111 with the FZC detection signal.

The data processing section 111 performs decode processing on a binary RF signal supplied from the RF amplifier 105, generates an information signal such as audio/video data or the like, and supplies an audio/video circuit not shown with the generated audio/video data.

Also, the data processing section 111 recognizes whether the optical disc 102 is, for example, a CD or DVD on the basis of the disc determination result information supplied from the disc determination section 108. Further, if the optical disc 102 is a DVD, the data processing section 111 recognizes whether one side includes one layer or two layers.

Upon supply of a FOK detection signal from the FOK signal detecting section 107 and further upon supply of a FZC detection signal from the FZC signal detecting section 110, the data processing section 111 recognizes that a focus of laser light irradiated from two-focus lens which is coming closer to the optical disc in the direction toward the disc passes over a focus position with respect to the signal recording surface of the optical disc 102.

Thereafter, the data processing 111 supplies the focus servo 112 with a control signal for stopping the two-focus lens moving closer to the optical disc 102, after a predetermined period from when the FOK detection signal is not supplied any more. In this manner, the approach operation of the two-focus lens toward the optical disc 102 is stopped after a predetermined period.

Thereafter, the data processing section 111 sets a hold period of, for example, 10 ms from when the approach operation of coming closer to the disc is stopped. Thereafter, the section 111 supplies the focus servo 112 with a control signal for starting down-search. A predetermined hold period is thus set after the approach operation is stopped, because the two-axis actuator of the optical pickup 104 vibrate in the optical axis direction of the optical lens, and the FOK signal outputted from the FOK signal detecting section 107 chatters and is supplied to the data processing section 111, if the operation is suddenly switched to down-search after stopping the approach operation.

Further, the data processing section 111 generates a control signal for focusing the lens with respect to the signal surface of the optical disc 102, based on the FOK detection signal supplied from the FOK signal detecting section 107 and the FZC detection signal supplied from the FZC signal detecting section 110. The data processing section 111 supplies the focus servo 112 with the generated control signal, thereby causing the focus servo to focus on the signal surface of the optical disc 102.

The focus servo 112 drives and controls the motion of the two-focus lens so as to focus on the signal surface of the optical disc 102, by means of the two-axis actuator of the optical pickup 104, based on the control signal supplied from the data processing section 111 to focus the lens on the signal surface of the optical disc 102. The tracking servo 113 drives and controls the motion of the two-focus lens so as to track on the track of the optical disc 102 by means of the two-axis actuator of the optical pickup 104, based on the control signal for making control of the tracking, which is supplied from the error signal detecting section 109.

In the optical disc apparatus 101 constructed as described above, the focus servo 112 lets the two-focus lens move in the direction in which the lens comes closer to the optical disc 102, based on a control signal supplied from the data processing section 111. Up-search is stopped after a predetermined period from when a focus position is once passed by. Thereafter, the focus servo 112 lets the two-focus lens move at a constant speed in the direction in which the lens comes more apart from the optical disc 102, and drives and controls the motion of the two-focus lens so as to focus on the signal surface of the optical disc 102, based on a control signal supplied from the data processing section 111 to focus on the signal surface of the optical 102.

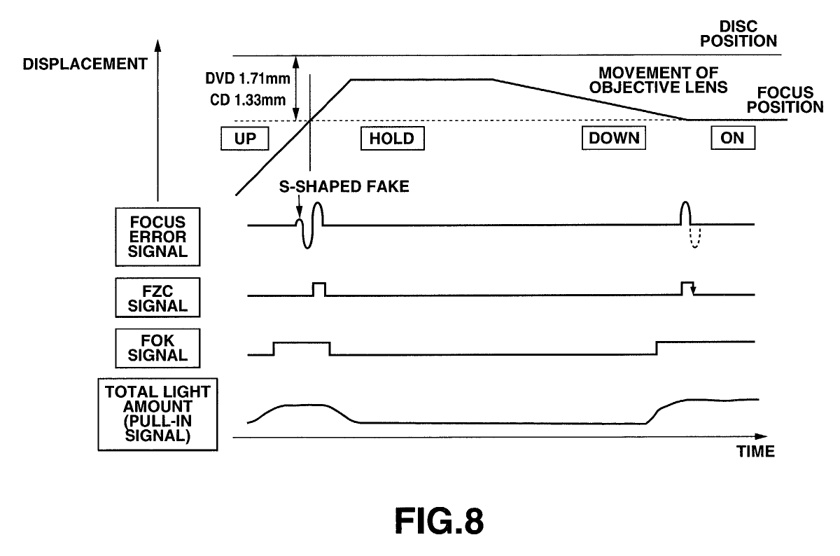

Next, in the optical disc apparatus 101, the two-focus lens is moved at a constant speed in the direction in which the lens comes closer to the optical disc 102. Up-search is stopped after a predetermined time from when a focus point is passed. Thereafter, the two-focus lens is focused on the optical disc 102 in the direction in which the lens comes apart from the optical disc 102, thereby to achieve down-search. The flow of this processing will be explained with reference to FIG. 8.

As a prerequisite, the optical disc apparatus 101 is in a state that the PI signal is not yet detected by the PI signal detecting section 6 but the two-focus lens is moving at a constant speed in the direction in which the lens comes closer to the optical disc 102 as a CD, for example.

At first, the PI signal detecting section 106 detects a PI signal and then generates a FOK signal, based on the detected PI signal. The section 106 supplies the FOK signal detecting section 107 with the FOK signal.

At this time, the FOK signal becomes “H” as shown in FIG. 8. Upon detection of the FOK signal supplied from the PI signal detecting section 106, the FOK signal detecting section 107 generates a FOK detection signal and supplies the data processing section 111 with the FOK detection signal.

Subsequently, upon detection of a FE signal, the error signal detecting section 109 generates a FZC signal based on the detected FE signal and supplies the FZC signal detecting section 110 with the FZC signal. At this time, the FZC signal becomes “H” as shown in FIG. 8. Further, upon detection of the FZC signal supplied from the error signal detection section 109, the FZC signal detecting section 110 generates a FZC detection signal and supplies the data processing section 111 with the FZC detection signal.

Thus, the data processing section 111 is supplied with the FOK detection signal from the FOK signal detecting section 107 and further supplied with the FZC signal detection signal from the FZC signal detecting section 110. Then, the data processing section 111 recognizes that the focus of the laser beam irradiated from the two-focus lens has passed by the focus position with respect to the signal recording surface of the optical disc 102, while the two-focus lens is moving in the direction in which the lens comes closer to the optical disc 102.

Thereafter, the data processing section 111 supplies the focus servo 112 with a control signal for stopping the approach operation of the two-focus lens toward the optical disc 102, after a predetermined period from when supply of the FOK detection signal is stopped. Once the focus servo 112 is supplied from the data processing section 111 with a control signal for stopping the approach operation of the two-focus lens toward the optical disc 102, the focus servo 112 controls the two-focus lens so as to stop the approach operation toward the operation disc 102 after a predetermined period.

Subsequently, the data processing section 111 sets a hold period of, for example, 10 ms after the approach operation is stopped. Thereafter, the section 111 supplies the focus servo 112 with a control signal for starting down-search. Based on the control signal supplied from the data processing section 111, the focus servo 112 stops the motion of the two-focus lens for a period of about 10 ms and then controls the operation of the two-focus lens so as to make down-search in the direction in which the lens comes apart from the optical disc 102.

Subsequently, the data processing section 111 generates a control signal for focusing on the signal surface of the optical disc 102, based on the FOK detection signal supplied from the FOK signal detecting section 107 and the FZC detection signal supplied from the FZC signal detecting section 110. The data processing section 111 supplies the focus servo 112 with the generated control signal. Further, based on the control signal supplied from the data processing section 111, the focus servo 112 controls the operation of the two-focus lens so as to focus on the signal surface of the optical disc 102.

By the processing as described above, it is possible to avoid a failure of switch-on of the focus, i.e., a signal called an S-shaped fake is mistaken as an error signal and the focus servo is turned on even in case where a CD is reproduced with use of an optical disc apparatus 101 As has been described above, in the optical disc apparatus 101 as a second embodiment of the present invention to which the present invention is applied, a signal called an S-shaped fake is prevented from occurring immediately before a FE signal due to a spherical aberration when the two-focus lens is focused in the direction in which the lens is moved closer to the optical disc 2, by making focus down-search with use of a FZC signal and/or a FOK signal. Accordingly, it is possible to prevent a failure of switch-on of focusing, mistaking this signal called an S-shaped as a FE signal.

Also, in the optical disc apparatus 101 as an embodiment to which the present invention is applied, the operation of moving the two-focus lens to the optical disc is controlled by a return signal from the optical disc 102. Therefore, the processing of preventing the two-focus lens and the optical disc 2 from contacting each other is carried out.

In the optical disc apparatus 101 described above, a CD or a DVD is used as the optical disc 2. Any other disc than a CD and a DVD can be used as long as the disc is of an optical type.

Also, in the optical disc apparatus 101 described above, the data processing section 111 supplies the focus servo 112 with a control signal for stopping the approach operation of the two-focus lens toward the optical disc 102, after a predetermined period from when no FOK detection signal is supplied any more. However, a control signal for stopping of the two-focus lens toward the optical disc 102 may be supplied to the focus servo 112 after a predetermined time from when no FZC signal is supplied any more, alternately.

What is claimed is:

1. An optical disc apparatus comprising:
an optical pickup for irradiating a light beam through a two-focus lens onto a signal recording surface of an optical disc including the signal recording surface where digital data is recorded to be optically readable, and for detecting reflection light thereof;
drive control means for driving and controlling the two-focus lens in an optical axis direction of the light beam;
focus error center value measurement means for measuring a focus error center value detected by the optical pickup;
focus error signal generation means for generating a focus error signal subjected to balance-adjustment based on the reflection light and a variable coefficient Kf; and
focus balance control means for causing the drive control means to control a focus balance, based on the focus error center value measured by the focus error center value measurement means, and the focus error signal generated by the focus error signal generation means and subjected to the balance adjustment.

2. The optical disc apparatus according to claim 1, further comprising:
focus bias voltage supply means for supplying the drive control means with a focus bias voltage; and
focus bias control means for causing the focus bias voltage supply means to supply the drive control means with the focus bias voltage, thereby to cause the drive control means to control a focus bias.

3. The optical disc apparatus according to claim 1, wherein the two-focus lens forms two focus positions by one single objective lens, corresponding to a plurality of discs having respectively different disc substrate thicknesses.

4. The optical disc apparatus according to claim 1, wherein the focus error center value measurement means measures an error center value with the two-focus lens kept sufficiently distant from a just-focus position.

5. The optical disc apparatus according to claim 1, wherein a plurality of values including an initial value used as a reference are set and stored for the coefficient Kf.

6. An optical disc apparatus comprising:
an optical pickup for irradiating a light beam through a two-focus lens onto a signal recording surface of an optical disc including the signal recording surface where digital data is recorded to be optically readable, and for detecting reflection light thereof;
drive control means for driving and controlling the two-focus lens in a radial direction of the optical disc;
tracking error center value measurement means for measuring a tracking error center value detected by the optical pickup;
tracking error signal generation means for generating a tracking error signal subjected to balance-adjustment based on the reflection light and a variable coefficient Kt; and
tracking balance control means for causing the drive control means to control a tracking balance, based on the tracking error center value measured by the tracking error center value measurement means, and the tracking error signal generated by the tracking error signal generation means and subjected to the balance adjustment.

7. The optical disc apparatus according to claim 6, further comprising:
tracking bias voltage supply means for supplying the drive control means with a tracking bias voltage; and
tracking bias control means for causing the tracking bias voltage supply means to supply the drive control means with the tracking bias voltage, thereby to cause the drive control means to control a tracking bias.

8. The optical disc apparatus according to claim 6, wherein the two-focus lens forms two focus positions by one single objective lens, corresponding to a plurality of discs having respectively different disc substrate thicknesses.

9. The optical disc apparatus according to claim 6, wherein the tracking error center value measurement means measures an error center value with the two-focus lens kept sufficiently distant from a just-focus position.

10. The optical disc apparatus according to claim 6, wherein a plurality of values including an initial value used as a reference are set and stored for the coefficient Kt.

11. An optical disc apparatus comprising:
an optical pickup for irradiating a light beam through an objective lens onto a signal recording surface of an optical disc including the signal recording surface where digital data is recorded to be optically readable, and for detecting reflection light thereof;
focus error signal detection means for detecting a focus error signal, based on the reflection light detected by the optical pickup;
focus zero-cross detection signal detection means for detecting a focus zero-cross detection signal, based on the focus error signal detected by the focus error signal detection means; and
drive control means for driving and controlling the objective lens in an optical axis direction of the light beam,
wherein, if the objective lens is being driven at a predetermined speed in a direction in which a distance from the optical disc is shortened, the drive control means stops the objective lens moving closer to the optical disc upon elapse of a predetermined time period from when the focus zero-cross detection signal which has been by the focus zero-cross detection signal detection means is not detected any more, and if the objective lens is being driven after the stopping of the objective lens, in a direction in which the distance from the optical disc is increased, the drive control means controls a focus position of the light beam irradiated from the optical pickup to be focused on the signal recording surface of the optical disc, based on the focus zero-cross detection signal.

12. The optical disc apparatus according to claim 11, wherein if the objective lens is being driven at a predetermined speed in a direction in which a distance from the optical disc is shortened, the drive control means stops the objective lens moving closer to the optical disc upon elapse of a predetermined time period from when the focus zero-cross detection signal which has been detected by the focus zero-cross detection signal detection means is not detected any more, and if the objective lens is being driven after the objective lens is sopped for a predetermined time, in a direction in which the distance from the optical disc is increased, the drive control means controls a focus position of the light beam irradiated from the optical pickup to be focused on the signal recording surface of the optical disc, based on the focus zero-cross detection signal.

13. The optical disc apparatus according to claim 11, wherein the objective lens is the two-focus lens which forms two focus positions in an optical axis direction by one single objective lens, corresponding to a plurality of discs having respectively different disc substrate thicknesses.

14. An optical disc apparatus comprising:
an optical pickup for irradiating a light beam through an objective lens onto a signal recording surface of an optical disc including the signal recording surface where digital data is recorded to be optically readable, and for detecting reflection light thereof;
pull-in signal detection means for detecting a pull-in signal, based on a total light amount of the reflection light detected by the optical pickup;
FOK signal detection means for detecting an FOK signal, based on the pull-in signal detected by the pull-in signal detection means; and
drive control means for driving and controlling the objective lens in an optical axis direction of the light beam,
wherein, if the objective lens is being driven at a predetermined speed in a direction in which a distance from the optical disc is shortened, the drive control means stops the objective lens moving closer to the optical disc upon elapse of a predetermined time period from when the FOK signal which has been by the FOK signal detection means is not detected any more, and if the objective lens is being driven after the stopping of the objective lens, in a direction in which the distance from the optical disc is increased, the drive control means controls a focus position of the light beam irradiated from the optical pickup to be focused on the signal recording surface of the optical disc, based on the FOK signal.

15. The optical disc apparatus according to claim 14, wherein if the objective lens is being driven at a predetermined speed in a direction in which a distance from the optical disc is shortened, the drive control means stops the objective lens moving closer to the optical disc upon elapse of a predetermined time period from when the FOK signal which has been detected by the FOK signal detection means is not detected any more, and if the objective lens is being driven after the objective lens is sopped for a predetermined time in a direction in which the distance from the optical disc is increased, the drive control means controls a focus position of the light beam irradiated from the optical pickup to be focused on the signal recording surface of the optical disc, based on the FOK signal.

16. The optical disc apparatus according to claim 14, wherein the objective lens is a two-focus lens which forms two focus positions in an optical axis direction by one single objective lens, corresponding to a plurality of discs having respectively different disc substrate thicknesses.

17. An optical disc apparatus comprising:
an optical pickup for irradiating a light beam through an objective lens onto a signal recording surface of an optical disc including the signal recording surface where digital data is recorded to be optically readable, and for detecting reflection light thereof;
focus error signal detection means for detecting a focus error signal, based on the reflection light detected by the optical pickup;
focus zero-cross detection signal detection means for detecting a focus zero-cross detection signal, based on the focus error signal detected by the focus error signal detection means;
pull-in signal detection means for detecting a pull-in signal, based on a total light amount of the reflection light detected by the optical pickup;
FOK signal detection means for detecting an FOK signal, based on the pull-in signal detected by the pull-in signal detection means; and
drive control means for driving and controlling the objective lens in an optical axis direction of the light beam,
wherein, if the objective lens is being driven at a predetermined speed in a direction in which a distance from the optical disc is shortened, the drive control means stops the objective lens moving closer to the optical disc upon elapse of a predetermined time period from when the focus zero-cross detection signal which has been by the focus zero-cross detection signal detection means or the FOK signal which has been detected by the FOK signal detection means is not detected any more, and if the objective lens is being driven after the stopping of the objective lens, in a direction in which the distance from the optical disc is increased, the drive control means controls a focus position of the light beam irradiated from the optical pickup to be focused on the signal recording surface of the optical disc, based on the focus zero-cross detection signal and the FOK signal.

18. The optical disc apparatus according to claim 17, wherein if the objective lens is being driven at a predetermined speed in a direction in which a distance from the optical disc is shortened, the drive control means stops the objective lens moving closer to the optical disc upon elapse of a predetermined time period from when the focus zero-cross detection signal which has been detected by the focus zero-cross detection signal detection means or the FOK signal which has been detected by the FOK signal detection means is not detected any more, and if the objective lens is being driven after the objective lens is sopped for a predetermined time, in a direction in which the distance from the optical disc is increased, the drive control means controls a focus position of the light beam irradiated from the optical pickup to be focused on the signal recording surface of the optical disc, based on the focus zero-cross detection signal and the FOK signal.

19. The optical disc apparatus according to claim 17, wherein the objective lens is a two-focus lens which forms two focus positions in an optical axis direction, corresponding to a plurality of discs having respectively different disc substrate thicknesses, by one single objective lens.
